(19) United States
(12) Patent Application Publication
(10) Pub. No.: US 2004/0036190 A1
(43) Pub. Date: Feb. 26, 2004

(54) Gas diffusion electrode manufacturing method and fuel cell

(76) Inventor: Chie Yoshida, Okazaki-shi (JP)

Correspondence Address: BIRCH STEWART KOLASCH & BIRCH, PO BOX 747, FALLS CHURCH, VA, 22040-0747, US

(21) Appl. No.: 10/644,999

(22) Filed: Aug. 21, 2003

(30) Foreign Application Priority Data
Aug. 21, 2002 (JP) 2002-240338

(51) Int. Cl. C04B 35/00

(52) U.S. Cl. 264/105; 252/511; 524/495

(57) ABSTRACT

A gas diffusion electrode is manufactured by preparing a slurry containing an electrically conductive powder, carbon fibers, organic fibers and a resin in specific proportions, forming the slurry into a sheet, and heating and drying the sheet. The electrode has the volume resistivity, thermal conductivity and gas permeability required for use in fuel cells, exhibits a flexibility conducive to continuous production, and does not break under the application of pressure during electrode production or fuel cell assembly.

### BACKGROUND OF THE INVENTION

1. Field of the Invention

The present invention relates to a method of manufacturing gas diffusion electrodes which have excellent handleability and can be effectively used in fuel cells. The invention also relates to fuel cells made using such gas diffusion electrodes.

2. Prior Art

The electrode base in a fuel cell must have the ability to allow the diffusion and permeation therethrough of substances which take part in the current collecting function of the fuel cell and in electrode reactions. In addition, to enable stable production, the electrode base must also have a good handleability.

JP-A 10-36179 and JP-A 11-185771 teach the fabrication of gas diffusion electrodes by impregnating a thermoset resin into a nonwoven fabric or sheet composed of carbon fibers or organic fibers, then curing and burning. In this prior art, because the material is burned and carbonized, the resulting gas diffusing electrodes lack flexibility and thus have a handleability that leaves something to be desired.

JP-A 2000-299113 discloses a process for fabricating gas diffusion electrodes by separately dispersing a granular conductive substance and a fibrous conductive substance in a binder-containing aqueous solution, forming the resulting dispersions into two kinds of sheets, one having a coarse structure and the other having a dense structure, then stacking and pressing together the two differing sheets. The resulting electrode has a low electrical resistance, a good gas permeability, and does not readily break when subjected to applied pressure. However, because this diffusion electrode is produced from two differing sheets, one having a coarse structure and the other having a dense structure, the production process tends to be involved. A need thus exists for a simpler and more convenient method of fabricating gas diffusion electrodes for fuel cells.

### SUMMARY OF THE INVENTION

It is therefore one object of the invention to provide a method of manufacturing gas diffusion electrodes endowed with a good volume resistivity, thermal conductivity and gas permeability, and having also an excellent handleability. Another object of the invention is to provide fuel cells made using such gas diffusion electrodes.

We have discovered that gas diffusion electrodes obtained by preparing a slurry containing an electrically conductive powder, carbon fibers, organic fibers and a resin in specific proportions, forming the slurry into a sheet, and heating and drying the sheet have the volume resistivity, thermal conductivity and gas permeability required of gas diffusion electrodes for fuel cells, in addition to which they are also of good flexibility and thus have an excellent handleability.

Accordingly, the invention provides a method of manufacturing gas diffusion electrodes which includes the steps of preparing a slurry containing solids composed of (A) 50 to 90 wt % of an electrically conductive powder, (B) 5 to 50 wt % of carbon fibers, (C) 3 to 40 wt % of organic fibers, and (D) 5 to 40 wt % of a resin in a combined amount of 100 wt % for components A to D; forming the slurry into a sheet; then heating and drying the sheet.

The conductive powder has an average particle size of preferably 10 to 100 μm. The carbon fibers have a length of preferably 0.1 to 20 mm.

Heating and drying of the sheet is typically carried out using a continuous dryer.

The invention additionally provides a fuel cell obtained using the gas diffusion electrode manufactured by the foregoing method.

### DETAILED DESCRIPTION OF THE INVENTION

As noted above, the method of manufacturing gas diffusion electrodes according to the invention involves preparing a slurry containing (A) an electrically conductive powder, (B) carbon fibers, (C) organic fibers and (D) a resin, forming the slurry into a sheet, then heating and drying the sheet. “Sheet,” as used herein, refers to a body which is formed from the slurry by a papermaking process.

The electrically conductive powder used as component A in the invention may be any conductive substance capable of manifesting excellent electrical conductivity for an electrode. Specific examples include natural graphite, synthetic graphite, expanded graphite, carbon black and activated carbon. Of these, expanded graphite is preferred from the standpoint of conductivity and flexibility.

The content of the conductive powder, based on the solids in the slurry, is at least 50 wt %, and preferably at least 55 wt %, but not more than 90 wt %, and preferably not more than 80 wt %. Too little conductive powder makes it difficult to obtain the electrical conductivity required of the electrode. On the other hand, too much conductive powder lowers the electrode strength, in addition to which the slurry is less conducive to sheet formation, making it difficult to obtain an electrode of uniform quality.

It is advantageous for the conductive powder to have an average particle size of at least 10 μm, and preferably at least 30 μm, but not more than 100 μm, and preferably not more than 80 μm. An average particle size outside of the above range may make it difficult to form the slurry into a sheet. “Average particle size,” as used herein, refers to the value measured using a Microtrak particle size analyzer.

The carbon fibers used as component B in the invention may be any carbon fibers capable of enhancing electrode strength, handleability and electrical conductivity. Specific examples include PAN-based carbon fibers, pitch-based carbon fibers and phenolic resin-based carbon fibers. For a large compressive strength and tensile elongation at break, PAN-based carbon fibers are especially preferred.

The content of the carbon fibers, based on the solids in the slurry, is at least 5 wt %, and preferably at least 10 wt %, but not more than 50 wt %, and preferably not more than 40 wt %. At too low a carbon fiber content, the electrode has an inadequate strength and does not readily achieve a sufficient electrical conductivity. On the other hand, at too high a carbon fiber content, the slurry is less conducive to sheet formation, making it difficult to obtain an electrode of uniform quality.

It is advantageous for the carbon fibers to have a length of at least 0.1 mm, and preferably at least 3 mm, but not more than 20 mm, and preferably not more than 12 mm. Carbon fibers which are too long may mutually entangle, adversely affecting dispersibility in water, which can make it difficult to obtain a uniform electrode. On the other hand, fibers which are too short may compromise the strength and flexibility of the electrode.

The carbon fibers typically have a diameter of at least 1 μm, and preferably at least 5 μm, but not more than 20 μm, and preferably not more than 8 μm. If the carbon fibers have too large a diameter, the electrical conductivity in the thickness direction may decline. On the other hand, carbon fibers having too small a diameter may compromise the strength of the electrode.

The carbon fibers are preferably blended with the other slurry components after first being shredded into the form of fluff with a shredder. By pre-shredding the fibers in this way, even when mixed into water together with the other components, the carbon fibers disperse well within the water, enabling a gas diffusion electrode of uniform quality to be obtained.

The organic fibers serving as component C in the invention may be any type of organic fiber which is capable of enhancing the sheet formability of the slurry, which is capable of retaining the conductive powder, and which does not melt when heated at up to 300° C. Examples of suitable organic fibers include wood pulp, aramid fibers, rayon fibers and polyester fibers. Of these, aramid fibers are preferred on account of their chemical resistance and heat resistance.

The organic fibers have a length of generally at least 0.1 mm, and preferably at least 3 mm, but generally not more than 20 mm, and preferably not more than 12 mm. Organic fibers which are too long may entangle with each other, adversely affecting dispersibility in water, which can make it difficult to obtain a uniform electrode. On the other hand, fibers which are too short may compromise the strength of the electrode, in addition to which they may have a diminished ability to retain the conductive powder, which can result in a lower electrical conductivity.

The content of the organic fibers, based on the solids in the slurry, is at least 3 wt %, and preferably at least 5 wt %, but not more than 40 wt %, and preferably not more than 20 wt %. At too low an organic fiber content, the electrode has an inadequate strength in addition to which sheet formability is poor, making it difficult to obtain an electrode of uniform quality. On the other hand, at too high an organic fiber content, an electrode of sufficient electrical conductivity cannot be obtained.

The resin serving as component D in the invention may be any resin which melts at a heating temperature of up to 300° C., has the ability to bind together the other materials, and is capable of enhancing the flexibility of the gas diffusion electrode. Examples of suitable resins include thermoset resins such as phenolic resins, epoxy resins, melamine resins and unsaturated polyethylene resins; thermoplastic resins such as polyvinyl alcohols, polyethylene resins and polyester resins; and rubbers and elastomers. From the standpoint of electrode flexibility and handleability, the use of a thermoplastic resin is especially preferred.

The content of the resin, based on the solids in the slurry, is at least 5 wt %, and preferably at least 10 wt %, but not more than 40 wt %, and preferably not more than 25 wt %. At too low a resin content, the handleability of the gas diffusion electrode declines and shedding of the carbon increases. On the other hand, at too high a resin content, an electrode of sufficient electrical conductivity cannot be obtained.

The resin may be in liquid, granular or fibrous form, although a fibrous resin is preferable for good sheet formability and to minimize problems with the wastewater that is discharged during sheet formation.

No particular limitation is imposed on the order in which the above components are combined when preparing the slurry. For example, the slurry may be prepared by adding pre-shredded component B, and also components A and C, to an aqueous solution of component D, then agitating the mixture. The concentration of solids within the slurry may be selected as appropriate within a range that does not compromise sheet formability in the sheet-forming step described below, although the solids concentration is generally not more than 10 wt %, and preferably not more than 3 wt %. In addition to components A to D, the slurry may contain also any suitable additives which do not compromise the objects of the invention. Such additives are generally included in an amount, per 100 parts by weight of the solids of components A to D combined, of not more than 5 parts by weight, and preferably not more than 3 parts by weight. The additives are not subject to any particular limitation. Illustrative examples include dispersants, stabilizers, viscosity modifiers, anti-settling agents, thickening agents, sheet strength additives, surfactants having a flocculating action (especially polymeric flocculants), and yield enhancers.

Any suitable sheet-forming method may be used in the invention. For example, use may be made of a vacuum forming process in which suction is applied to the slurry containing the various above components within a vacuum forming die having a plurality of vacuum holes, causing the components to accumulate on the surface of the die. The density of the vacuum formed body obtained by this process can easily be controlled by means of the suction pressure.

Alternatively, the sheet may be formed as a continuous web using a commercial papermaking machine such as short wire former, a Fourdrinier machine, a cylinder machine or an inclined wire machine.

The sheet formed from the slurry containing components A to D is then heated and dried.

Although the method and conditions used for heating and drying are not subject to any particular limitations, it is generally desirable to set the drying temperature to at least 100° C., and preferably at least 130° C., but not more than 400° C., and preferably not more than 300° C. It is generally desirable to set the drying time to at least 1 minute, but not more than 60 minutes, and preferably not more than 30 minutes.

It is advantageous to carrying out heating and drying using a continuous dryer. Examples of suitable continuous dryers include cylinder dryers such as multi-cylinder dryers and Yankee dryers. By using such a continuous dryer, heating and pressurization can be carried out continuously at the same time, facilitating continuous production.

The gas diffusion electrodes obtained in this way are endowed with the volume resistivity, thermal conductivity and gas permeability required for use in fuel cells, in addition to which they have a good flexibility and thus excellent handleability. These qualities make them highly effective as gas diffusion electrodes in fuel cells.

### EXAMPLES

The following examples and comparative examples are provided to illustrate the invention and are not intended to limit the scope thereof.

### Examples 1 and 2, Comparative Examples 1 to 4

Electrically conductive powder, pre-shredded carbon fibers, organic fibers and resin were added to a 1 wt % aqueous solution of polyethylene oxide in the proportions shown in Table 1, then stirred with an agitator to prepare a slurry of these materials in a uniformly dispersed state. The slurry was formed into a web on an inclined short wire former and subsequently heated and dried at 150° C. for 2 minutes in a continuous dryer, thereby yielding gas diffusion electrodes. The properties of the gas diffusion electrodes are presented in Table 1.

TABLE 1

| | | | Example | | Comparative Example | | | |
|---|---|---|---|---|---|---|---|---|
| | | | 1 | 2 | 1 | 2 | 4 | 4 |
| Composition | Expanded graphite | | 70 | 70 | 90 | 45 | 90 | 45 |
| (wt %) | Carbon fibers | | 10 | 10 | | 5 | | 5 |
| | Aramid fibers | | 10 | 10 | | 5 | | 5 |
| | Resins | Phenolic resin | | 10 | | | 10 | 45 |
| | | Polyester resin | 10 | | 10 | 45 | | |

| | | | | | | | |
|---|---|---|---|---|---|---|---|
| Electrode | Thickness (μm)( | 69.5 | 82.3 | 78.8 | 103.5 | 101.2 | 121.8 |
| properties | Resistivity (Ω · cm) | 0.104 | 0.260 | 0.210 | 2.780 | 0.378 | 3.120 |
| | Gas permeability | 2.6 | 3.5 | | 27 | | 30 |
| | (s) | | | | | | |
| | Thermal conductivity | 1.210 | 0.425 | 0.411 | 0.077 | 0.319 | 0.082 |
| | (W/m · K) | | | | | | |
| | Roll winding | excellent | good | good | fair | poor | poor |

The ingredients used in the slurry and the characteristics measured are described below.

1. Expanded Graphite

Used as the electrically conductive powder. Produced by Marutoyo Chuzai Seisakusho KK under the trade name Calphite. Average particle size, 30 μm.

2. Carbon Fibers

Produced by Toho Tenax Co., Ltd. under the trade name Besfight. Fiber length, 6 mm.

3. Aramid Fibers

Used as the organic fibers. Produced by DuPont-Toray Co., Ltd. under the trade name Kevlar. Fiber length, 3 mm.

4. Phenolic Resin

Produced by Gun Ei Chemical Industry Co., Ltd. under the trade name Resitop XPG-4617B.

5. Polyester Resin

Produced by Teijin Ltd. under the trade name Tepyrus TJO4CNSD.

6. Polyethylene Oxide

Produced by Sumitomo Chemical Co., Ltd. under the trade name PEO.

7. Thickness

Measured with a micrometer made by Mitutoyo Corporation.

8. Resistivity

Measured using a Loresta SP Model MCP-T500 resistivity meter made by Mitsubishi Chemical Corporation.

9. Gas Permeability

Measured by the Gurley permeability test method in accordance with JIS P-8117.

10. Thermal Conductivity

Measured using a QTM-500 thermal conductivity meter manufactured by Kyoto Electronics Manufacturing Co., Ltd., in accordance with JIS R-2616.

11. Roll Winding

The flexibility when the electrodes were wound onto a 4 cm diameter metal roll was rated according to the following criteria.

Excellent: Very easy to wind. No cracking or bending observed after winding.

Good: Easy to wind, but some signs of bending appeared after winding.

Fair: Winding was possible, but many cracks and creases appeared after winding.

Poor: Broke during winding, making winding impossible.

As is apparent from the results given above, the gas diffusion electrodes of the invention have good flexibility and can therefore be wound into rolls, enabling continuous production. Moreover, these diffusion electrodes have the volume resistivity, thermal conductivity and gas permeability required for use in fuel cells, and do not break up under the application of pressure during electrode production or fuel cell assembly.

The inventive method of manufacturing gas diffusion electrodes is composed of simple steps and is thus capable of holding down production costs, which is highly beneficial for industrial purposes.

Japanese Patent Application No. 2002-240338 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method of manufacturing gas diffusion electrodes comprising the steps of:
(a) preparing a slurry containing solids composed up of:
(A) 50 to 90 wt % of an electrically conductive powder,
(B) 5 to 50 wt % of carbon fibers,
(C) 3 to 40 wt % of organic fibers, and
(D) 5 to 40 wt % of a resin,
in a combined amount of 100 wt % for components A to D;
(b) forming the slurry into a sheet; and
(c) heating and drying the sheet.

2. The method of claim 1, wherein the conductive powder has an average particle size of 10 to 100 μm.

3. The method of claim 1, wherein the carbon fibers have a length of 0.1 to 20 mm.

4. The method of claim 1, wherein heating and drying of the web is carried out using a continuous dryer.

5. A fuel cell containing the gas diffusion electrodes manufactured by the method of claim 1.
